(19) United States
(12) Patent Application Publication
(10) Pub. No.: US 2012/0124891 A1
(43) Pub. Date: May 24, 2012

(54) DISPENSING DEVICE FOR RODENT BAITS

(75) Inventors: Vladan Jovic, New South Wales (AU); Duncan McLeod Watson, Montvale, NJ (US)

(73) Assignee: Reckitt & Colman (Overseas Limited), Slough (GB)

(21) Appl. No.: 13/377,636

(22) PCT Filed: Jun. 8, 2010
(86) PCT No.: PCT/GB10/50955

§ 371 Date: Jan. 12, 2012

(30) Foreign Application Priority Data
Jun. 26, 2009 (GB) 0911116.2

(51) Int. Cl. A01M 25/00

(52) U.S. Cl. 43/131

(57) ABSTRACT

There is disclosed herein a dispensing device (100, 200, 300) for rodent baits. The dispensing device includes a body (102, 202, 302) having a floor (104, 204, 304), walls (106, 206, 306) extending from the floor and a top (108, 208, 308) extending between the walls. A rodent bait station (110, 210, 310) is located in the body (102, 202, 302). A locating spike (112, 212, 312) extends from the bait station for engagement by a bait (114, 214, 314). A race (116, 216, 316) extends into the body (102, 202, 302) for permitting rodent access to the bait station (110, 210, 310). A plurality of liquid ingress inhibiting formations are provided in the race (116, 216, 316) for inhibiting liquid contact with a bait (114, 214, 314) in the bait station (110, 210, 310).

The present disclosure relates to a dispensing device and in particular to a dispensing device for rodent baits.

The dispensing device has been developed primarily for use in dispensing baits containing poison for exterminating rodents, such as mice and rats. However, it will be appreciated that the dispensing device may also be used for dispensing poisonous chemicals, for controlling other vermin, including voles and crawling insects, such as cockroaches and ants, or for dispensing non-poisonous baits/chemicals for therapeutic treatment of wildlife or for monitoring rodent populations.

Known rodent bait dispensing devices typically include a bait box with a hinged lid allowing access to a bait pedestal on which a poisonous bait can be mounted.

A problem with known rodent bait dispensing devices is that liquids, such as rain or spills, can enter and reach the bait, which can damage, spoil or otherwise reduce the longevity of the bait. Also, the bait can become degraded as a result of contact with the liquid.

A further problem associated with known bait dispensing devices is that they can fail when exposed to weather extremes, such as extremes of humidity, temperature, UV radiation, and wind. For example, known bait dispensing devices can become brittle and crack when exposed to low temperatures and/or high UV radiation. Known bait dispensing devices can also fail due to deformation resulting from exposure to extreme temperatures, which may cause, for example, the lid to undesirably open or to cease shut. Extremes of wind can also cause known bait stations undesirably to move or overturn, which can release bait into the surrounding environment, damage the bait dispensing device and/or impede its operation.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

There is provided a dispensing device for rodent baits, the dispensing device comprising:

a body having a floor, walls extending from the floor and a top extending between the walls;

a station located in the body for receiving a rodent bait;

a race extending into the body for permitting rodent access to the station;

a plurality of liquid ingress inhibiting formations in or around the race for inhibiting liquid contact with a bait in the station.

The liquid ingress inhibiting formations preferably include a plurality of baffles extending from the floor toward the top of the body. The baffles preferably extend at least part way across the race. The baffles are preferably oriented to direct liquid in the race away from the station. The baffles are preferably oriented to direct liquid in the race toward one of the walls of the body. At least one drainage opening is preferably provided in the floor and the baffles are preferably oriented to direct liquid in the race toward a said drainage opening.

The liquid ingress inhibiting formations preferably include at least one drainage opening in the floor. The at least one drainage opening is preferably located adjacent one of the walls of the body.

The liquid ingress inhibiting formations preferably include one or more sloped sections in the floor of the body. One of the sloped sections is preferably adapted to direct liquid in the race toward one of the walls of the body. One of the sloped sections is preferably adapted to direct liquid in the race toward a drainage opening in the floor of the body. One of the sloped sections is preferably adapted to direct liquid in the race toward an inlet for rodent entry into the race. A ramped portion is preferably provided at an opening for rodent entry into the race to inhibit liquid entering the race. The gradients of the sloped sections are preferably between 1 and 15 degrees, more preferably between 3 and 10 degrees and most preferably approximately 6 degrees to approximately 8 degrees.

The liquid ingress inhibiting formations preferably include a raised portion on which the station is formed, such that the station is raised relative to the floor of the body. The raised portion preferably extends at least 2 mm above the floor, and more preferably at least 4 mm above the floor.

The liquid ingress inhibiting formations preferably include a waterproof perimeter preferably extends around the station. The waterproof perimeter is preferably complementary to the shape of the bait. The waterproof perimeter is preferably at least 2 mm high, and more preferably at least 4 mm high.

A door is preferably connected to the body, the door being movable between a closed position, in which the door covers the station, and an open position for permitting user access to the station for bait replenishment. The door is preferably hingedly connected to the body. A locking mechanism is preferably associated with the hinged door for releasably securing the door in the closed position. When viewed from the top of the body, operative components of the locking mechanism are preferably located outside a perimeter of the station. The door preferably includes a top portion extending over the station when the door is in the closed position. When viewed from the top of the body, the door periphery is preferably located outside a perimeter of the station. The liquid ingress inhibiting formations preferably include a ribbed section in the floor of the body for dispersing liquid that may fall from the top of the body. The ribbed section is preferably located under an intersection between the top portion of the door and the top of the body, when the door is in the closed position. Ribs of the ribbed section are preferably oriented in a direction away from the station. A baffle is preferably provided at an end of the ribbed section distal from the station and extending generally transverse to the ribs. A drainage path from the ribbed section preferably extends around the baffle toward a drainage opening in the floor. The liquid ingress inhibiting formations preferably include a drain extending around a periphery of the door. The drain preferably directs liquid accumulating on the top of the body or the top of the door to flow around the periphery of the door to a drainage point. The drain is preferably formed in the body and preferably takes the form of a channel. The liquid ingress inhibiting formations preferably include a waterproof sleeve portion extending around the hinge between the door and the body. An end of the sleeve portion adjacent the floor preferably terminates in a drainage opening. The liquid ingress inhibiting formations preferably include at least one tab extending from a top portion of the door to engage a corresponding recess in the body, overlapping areas between the at least one tab and the corresponding recess defining liquid dripping points located outside a perimeter of the station. The liquid ingress inhibiting formations preferably include a flange extending from the body, adjacent the door hinge, to direct liquid entering between the door and the body away from the station. The flange preferably extends from the floor toward the top of the body.

In some embodiments, the body may include a lip extending part-way from the floor toward the top of the body to inhibit liquid entering the race. In such embodiments, a height of the lip is less than a height of a waterproof perimeter extending around the station or the raised portion on which the station is formed.

The floor of the body is preferably formed from a hydrophobic material. The floor is preferably formed from a plastics material, most preferably polypropylene. The walls and top of the body are preferably also formed from polypropylene.

The door is preferably translucent to allow the amount of bait in the station to be judged when the door is in the closed position.

The bait for use with the bait dispensing device is preferably water resistant and preferably contains a relatively high proportion of wax.

Preferred embodiments are described below, by way of example only, with reference to the accompanying drawings, in which:

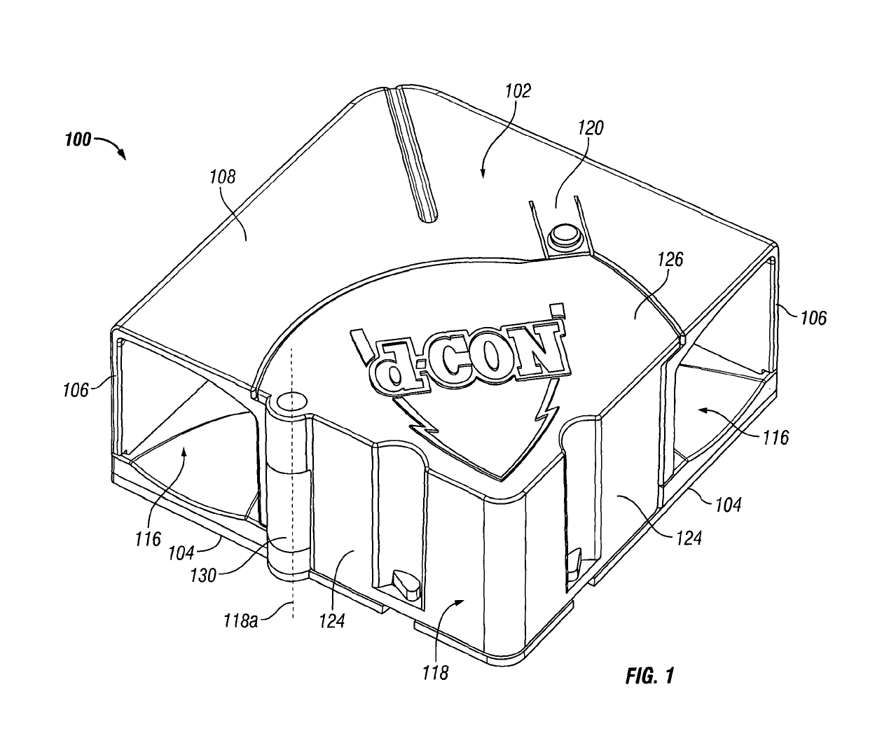

FIG. 1 is a top perspective view of a first embodiment of a dispensing device for rodent baits, shown with its door closed;

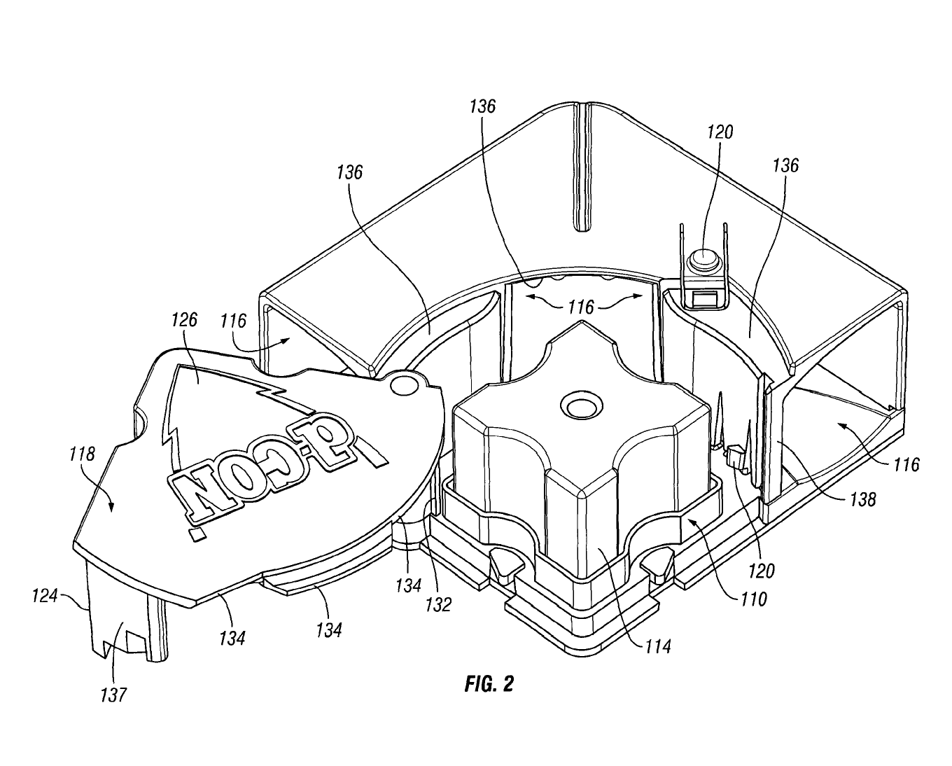

FIG. 2 is a top perspective view of the dispensing device of FIG. 1, shown with its door open;

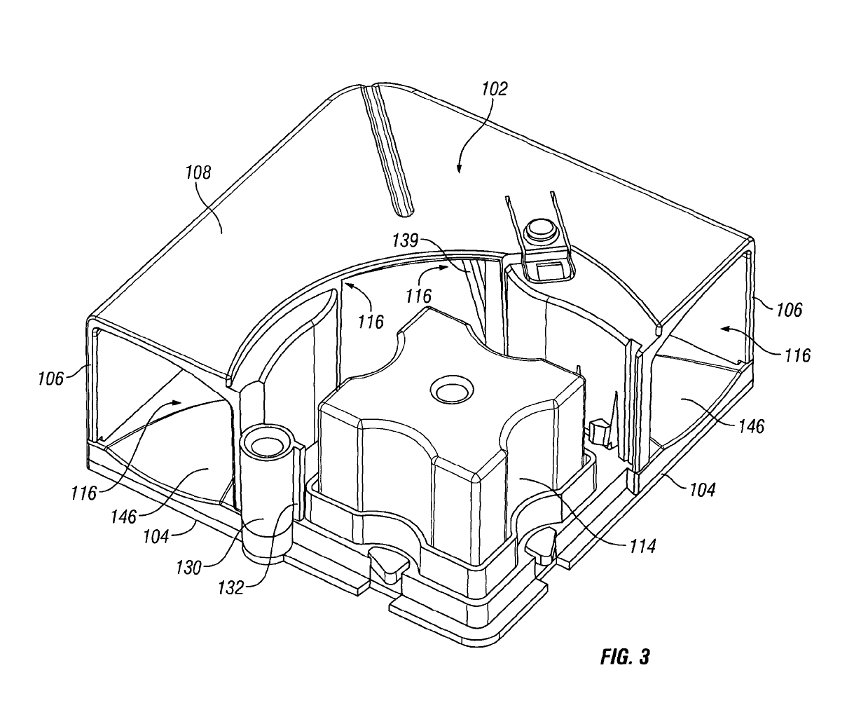

FIG. 3 is a top perspective view of the dispensing device of FIG. 1, with the door removed to show internal components of the device body;

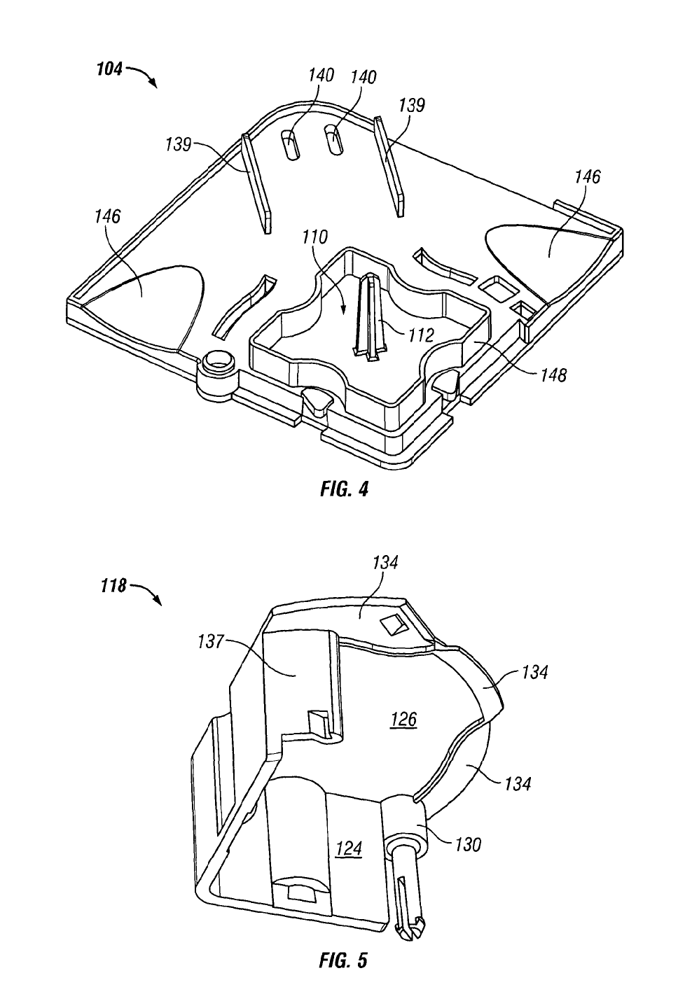

FIG. 4 is a top perspective view of the door of a floor portion of the dispensing device of FIG. 1;

FIG. 5 is an underside perspective view of the door of the dispensing device of FIG. 1;

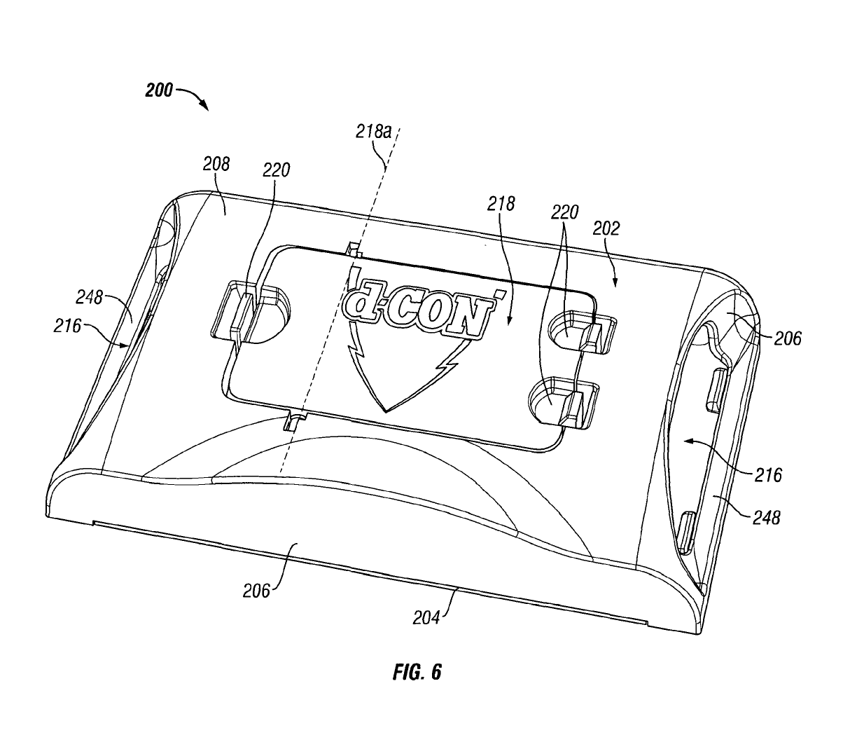

FIG. 6 is a top perspective view of a second embodiment of a dispensing device for rodent baits, shown with its door closed;

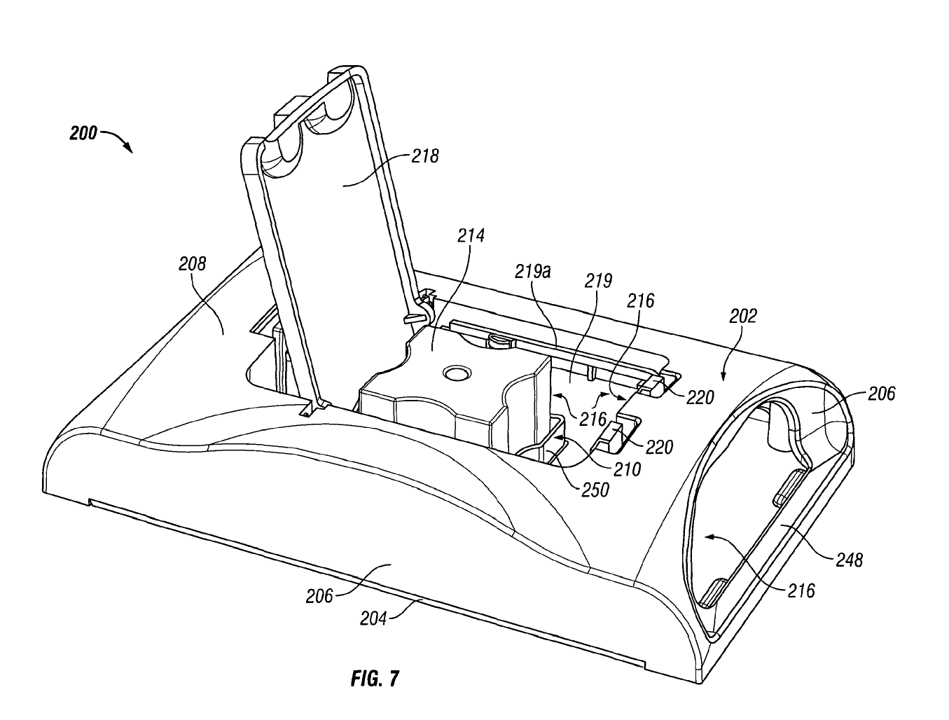

FIG. 7 is a first top perspective view of the dispensing device of FIG. 6, shown with its door open to allow internal components to be seen;

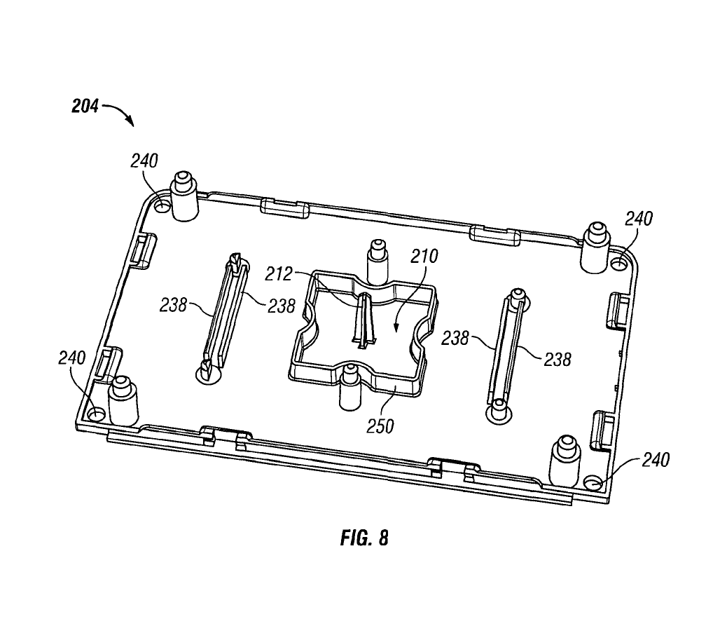

FIG. 8 is a top perspective view of a floor portion of the dispensing device of FIG. 6;

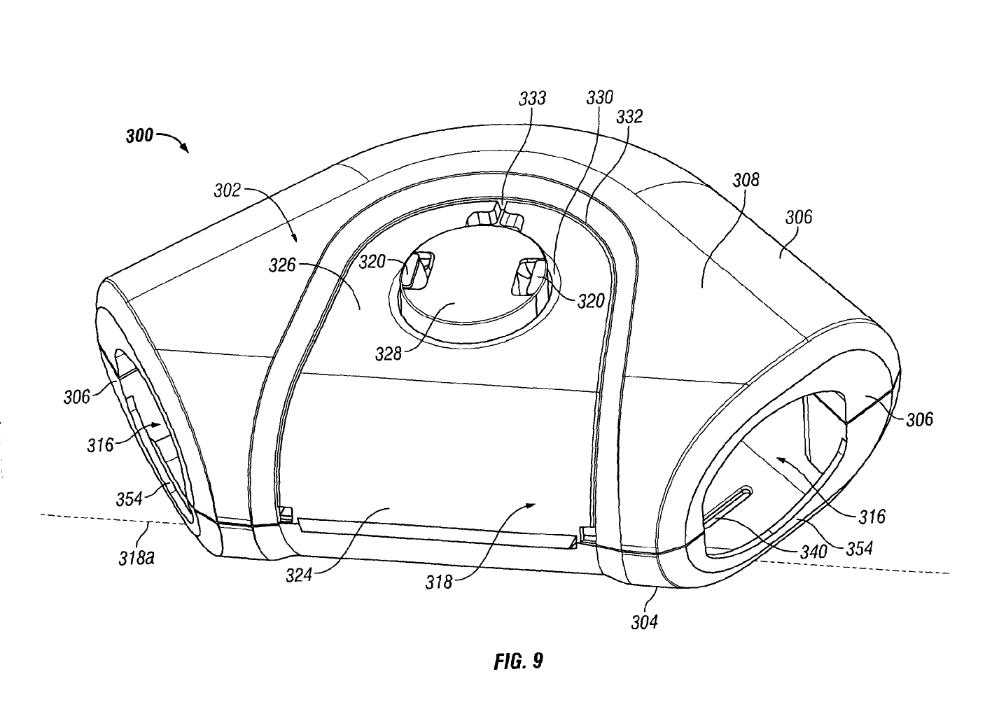

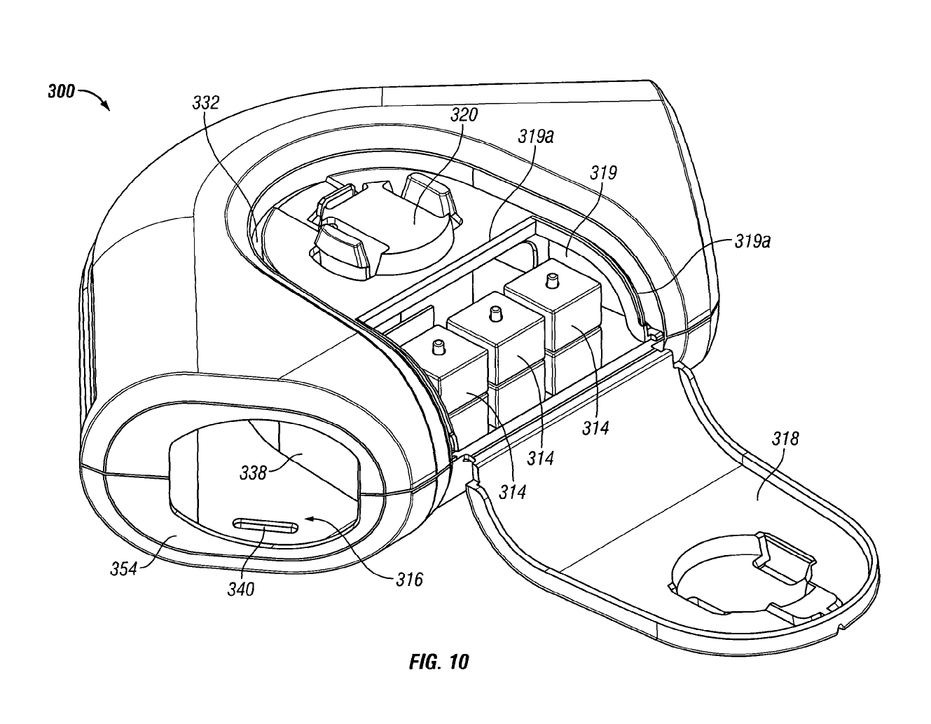

FIG. 9 is a front top perspective view of a third embodiment of a dispensing device for rodent baits, shown with its door closed;

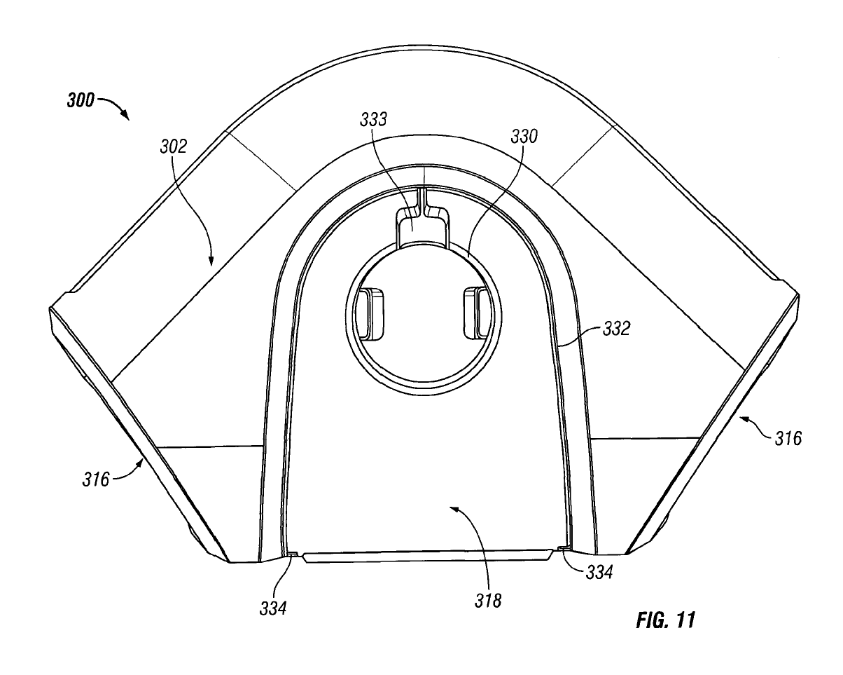

FIG. 10 is a front top perspective view of the dispensing device of FIG. 9, shown with its door open; and

FIG. 11 is a plan view of the dispensing device of FIG. 9, shown with its door closed; and

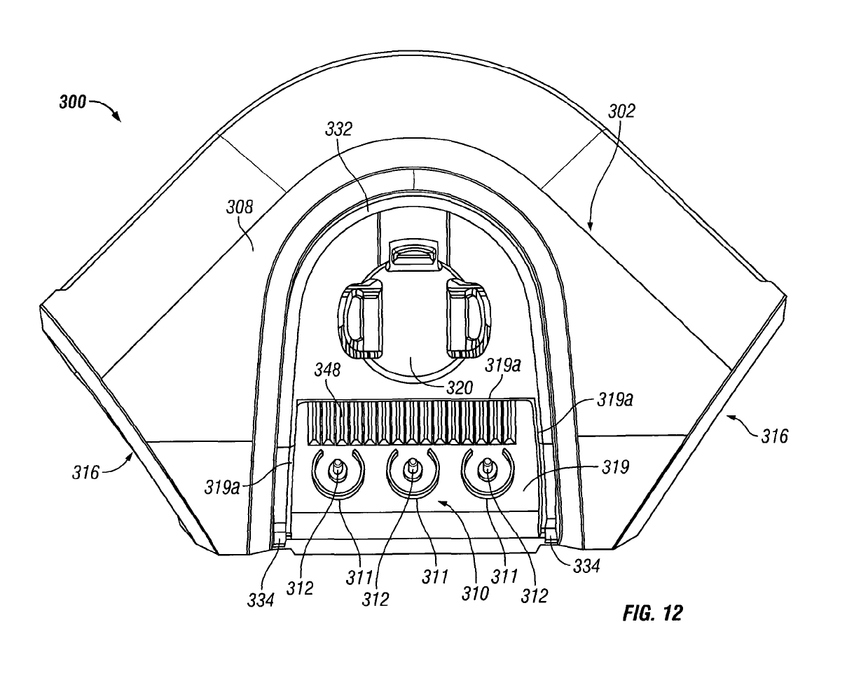

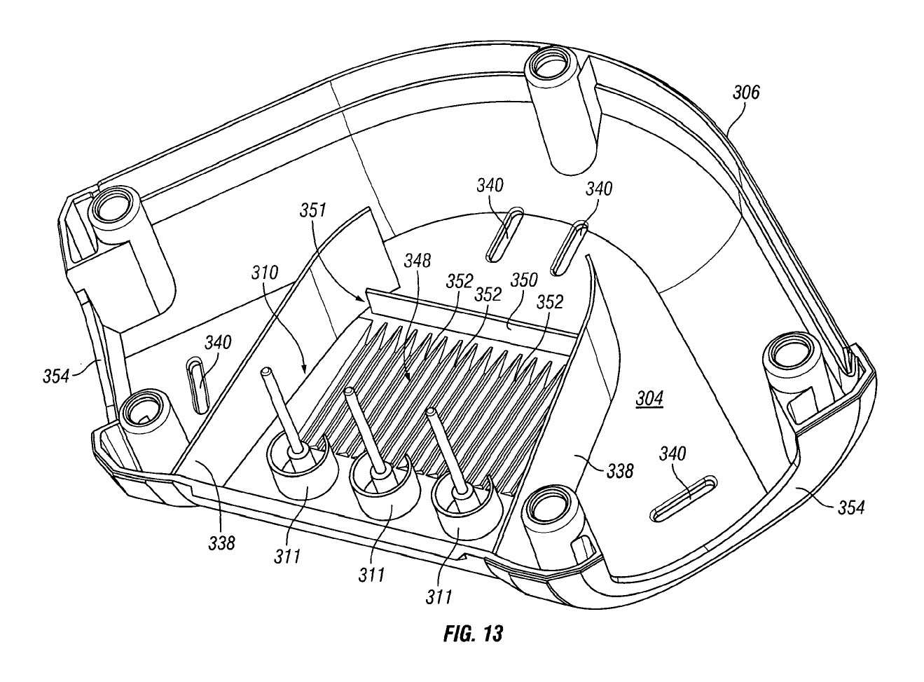

FIG. 12 is a plan view of the dispensing device of FIG. 9, shown without its door and without baits; and

FIG. 13 is a top perspective view of a floor portion of the dispensing device of FIG. 9, shown without its door and without baits.

Referring to FIGS. 1-5 of the drawings, there is shown a first embodiment of a dispensing device 100 for rodent baits. The dispensing device 100 includes a body 102 having a floor 104, walls 106 extending from the floor and a top 108 extending between the walls 106. A rodent bait station 110 is located in the body 102. A locating spike 112, as shown in FIG. 4, extends from the bait station 110 for engagement by a bait 114. A race 116 extends into the body 102 for permitting rodent access to the bait station 110. A door 118 is hingedly connected, about a hinge axis 118a generally orthogonal to the floor 104, to the body 102. The door 118 is movable between a closed position, as shown in FIG. 1, in which the door 118 covers the bait station 110, and an open position, as shown in FIG. 2, for permitting user access to the bait station 110 for bait replenishment. The door 118 is translucent to allow the amount of bait 114 in the bait station 100 to be judged when the door is in the closed position of FIG. 1.

The door 118 includes a side portion 124 cooperating with the walls 106 of the body 102 to enclose the bait station 110 and a cover portion 126 cooperating with the top 108 of the body to enclose the bait station 110 when the door is in the closed position of FIG. 1. As can be seen by comparing FIGS. 1 and 2, the door 118 is rotatable about its hinge axis 118a relative to the body 102 through almost 180 degrees. A locking mechanism 120 is associated with the door 118 for releasably securing the door in the closed position of FIG. 1.

When viewed from the top 108 of the body, operative components of the locking mechanism 120 and the periphery of the door 118 are located outside a perimeter of the bait station 110. Accordingly, any liquid that may unintentionally enter through the join between the door 118 and body 102, or through the locking mechanism 120, will fall outside the bait station 110.

A plurality of liquid ingress inhibiting formations are provided in the race 116 for inhibiting liquid contact with a bait 114 in the bait station 110. The liquid ingress inhibiting formations include a waterproof sleeve portion 130 extending around the hinge between the door 118 and the body 102. A lower end of the sleeve portion 130 adjacent the floor 104 terminates in a drainage opening. The liquid ingress inhibiting formations further include a flange 132 extending from the body 102, adjacent the door hinge, to direct liquid entering between the door 118 and the body 102 away from the bait station 110. The flange 132 extends from the floor 104 toward the top 108 of the body.

As best seen in FIGS. 2 and 5, the liquid ingress inhibiting formations also include tabs 134 extending from a top portion of the door 118 to engage corresponding recesses 136 in the body 102. A tab 137 also extends from a side portion of the door 118 for overlapping engagement with a wall of the 138 of the body. The overlapping of the tabs 134, 137 with the corresponding portions of the body at least slows liquid entering the race 116 around the door 118. The location of the points of overlapping are also designed so as to be outside the bait station 110, such that any associated liquid drip points are outside the bait station 110.

The liquid ingress inhibiting formations further include a plurality of baffles 139 extending from the floor 104 toward the top 108 of the body and extending at least part way across the race 116. The baffles 139 are oriented to direct liquid in the race 116 away from the bait station 110 toward a rear wall 106 of the body, distal from the bait station 110, and into one of a plurality of drainage openings 140 in the floor 104, which are located adjacent the rear wall.

The floor 104 of the body is sloped away from the bait station 110 and toward drainage points defined by rodent entrances to the race 116 and the drainage openings 140. Scallop shaped ramped portions 146 are provided at an opening for rodent entry into the race 116 to inhibit liquid entering the race. The gradient of the ramped portions is approximately 6 degrees.

A waterproof perimeter 148, approximately 6 mm high, extends around the bait station 110. The waterproof perimeter 148 is complementary to the shape of the bait 114.

The floor of the body is formed from polypropylene, which is a hydrophobic material, to facilitate beading of water in the race 116, to facilitate drainage of water toward the drainage openings. The walls and top of the body are also formed from polypropylene. Polypropylene has been chosen as the predominant material for the body 102 due to its good impact resistance, tensile strength, chemical resistance, resistance to rain and humidity, UV stability, and serviceability through a temperature range of at least −10° C. to 50° C.

The bait 114 for use with the bait dispensing device is preferably water resistant, containing a relatively high proportion of wax, as well as mould inhibitors.

Referring to FIGS. 6-8, there is shown a second embodiment of a dispensing device 200 for rodent baits. The dispensing device 200 includes a body 202 having a floor 204, walls 206 extending from the floor and a top 208 extending between the walls 206. A rodent bait station 210 is located in the body 202. A locating spike 212 extends from the bait station 210 for engagement by a bait 214. A race 216 extends into the body 202 for permitting rodent access to the bait station 210. A door 218 is hingedly connected, about a hinge axis 218a, to the body 202 to selectively cover an opening 219 in the top of the body above the bait station 210. The door 218 is movable between a closed position, as shown in FIG. 6, in which the door 218 covers the bait station 210, and an open position, as shown in FIG. 7, for permitting user access to the bait station 210 for bait replenishment. In the closed position of FIG. 6, the door 218 engages a rim 219a around the opening 219. A locking mechanism 220 is associated with the door 218 for releasably securing the door in the closed position of FIG. 6. The door 218 is translucent to allow the amount of bait 214 in the bait station 210 to be judged when the door is in the closed position of FIG. 6.

When viewed from the top 208 of the body, operative components of the locking mechanism 220 and the periphery of the door 218 are located outside a perimeter of the bait station 210. Accordingly, any liquid that may unintentionally enter through the join between the door 218 and body 202, or through the locking mechanism 220, will fall outside the bait station 210.

A plurality of liquid ingress inhibiting formations are provided in the race 216 for inhibiting liquid contact with a bait 214 in the bait station 210. The liquid ingress inhibiting formations include the rim 219a around opening 219 in the body, which is overlapped and engaged by a periphery of the door 218 when in its closed position. This overlapping at least slows liquid entering the race 216 around the door 218. The location of the points of engagement between the door 218 and the rim 219a are also designed so as to be outside the bait station 210, such that any liquid that drips from the overlapping door 218 and rim 219a falls outside the bait station 210.

As shown in FIG. 8, the liquid ingress inhibiting formations further include a plurality of baffles 238 extending from the floor 204 toward the top 208 of the body and extending at least part way across the race 216. The baffles 238 are oriented to direct liquid in the race 216 away from the bait station 210 toward a wall 206 of the body distal from the bait station 210 and/or into one of a plurality of drainage openings 240 in the floor 204. Some of the drainage openings 240 are located adjacent walls 206 of the body.

As shown in FIGS. 6 and 7, a lip 248 is provided at the entrance to the race 216 and extends part-way from the floor 204 toward the top 208 of the body to inhibit liquid entering the race 216.

As shown in FIGS. 7 and 8, a waterproof perimeter 250, approximately 6 mm high, extends around the bait station 210. The waterproof perimeter 250 is complementary to the shape of the bait 214. The height of the waterproof perimeter 250 is greater than the height of the lip 248 to ensure that should the device 200 become flooded, water will drain from the race 216 over the lip 248 before overtopping the waterproof perimeter 250 surrounding the bait 214.

The materials used in the second embodiment are the same as those used in the first embodiment for the same reasons as discussed above with reference to the first embodiment.

Referring to FIGS. 9-13, there is shown a third embodiment of a dispensing device 300 for rodent baits. The dispensing device 300 includes a body 302 having a floor 304, walls 306 extending from the floor and a top 308 extending between the walls 306. A bait station 310 is provided in the body. As best shown in FIGS. 12 and 13, the bait station 310 includes raised platforms 311, approximately 6 mm high, extending from the floor 304 of the body 302. Locating spikes 312 extend from the platforms 311 for engagement by baits 314. A race 316 extends into the body 302 for permitting rodent access to the bait station 310. A door 318 is hingedly connected, about a hinge axis 318a generally parallel to the floor 304, to selectively cover an opening 319 in the body the body 302 adjacent the bait station 310. The hinge between the door 318 and the body 302 is integrally moulded, such that the door and body are of integral, one-piece construction. The door 318 is movable between a closed position, as shown in FIG. 9, in which the door 318 covers the bait station 310, and an open position, as shown in FIG. 10, for permitting user access to the bait station 310 for bait replenishment. In the closed position of FIG. 9, the door 318 engages a rim 319a around the opening 319. A locking mechanism 320 is associated with the door 318 for releasably securing the door in the closed position of FIG. 9. The door 318 is translucent to allow the amount of bait 314 in the bait station 310 to be judged when the door is in the closed position of FIG. 9.

As indicated in FIG. 9, the door 318 includes a side portion 324 cooperating with the walls 306 of the body 302 to enclose the bait station 310 and a cover portion 326 cooperating with the top 308 of the body to enclose the bait station 310 when the door is in the closed position of FIG. 9. A raised portion 328, with which the locking mechanism 320 is associated, is provided on the door 318.

A plurality of liquid ingress inhibiting formations are provided in the race 316 for inhibiting liquid contact with a bait 314 in the bait station 310. The liquid ingress inhibiting formations include a drainage channel 330 extending around the raised portion 328 to direct liquid away from the locking mechanism 320 and thereby inhibit liquid entering the race through the locking mechanism 320. Also, when viewed from the top 308 of the body, as shown in FIG. 12, operative components of the locking mechanism 320 and the periphery of the door 318 are located outside a perimeter of the bait station 310. Accordingly, any liquid that may unintentionally enter through the join between the door 318 and body 302, or through the locking mechanism 320, will fall outside the bait station 310.

The liquid ingress inhibiting formations further include a drain channel 332 formed in the body 302 and extending around a periphery of the door 318. The drain channel 332 directs liquid accumulating on the top of the body 302 or the top of the door 318 to flow around the periphery of the door to drainage points 334 located away from the bait 314. The drainage channel 330 around the raised portion 328 feeds into the drain channel 332 via an interconnecting drain portion 333.

The liquid ingress inhibiting formations further include the rim 319a around opening 319 in the body, which is overlapped and engaged by a periphery of the door 318 when in its closed position. This overlapping at least slows liquid entering the race 316 around the door 318. The location of the points of engagement between the door 318 and the rim 319a are also designed so as to be outside the bait station 310, such that any liquid that drips from the overlapping door 318 and rim 319a falls outside the bait station 310.

The liquid ingress inhibiting formations further include a plurality of baffles 338 extending from the floor 304 toward the top 308 of the body and extending at least part way across the race 316. The baffles 338 are oriented to direct liquid in the race 316 away from the bait station 310 toward a wall 306 of the body distal from the bait station 310 and/or into one of a plurality of drainage openings 340 in the floor 304. Some of the drainage openings 340 are located adjacent walls 306 of the body.

The floor 304 of the body is sloped away from the bait station 310 and toward drainage points defined by the drainage openings 340, 352. The floor 304 includes portions having slopes up to approximately 8 degrees.

The liquid ingress inhibiting formations further include a ribbed section 348 in the floor 304 of the body for dispersing liquid that may fall from the top 308 of the body. The ribbed section 348 is located under an intersection between the door 318 and the top 308 of the body, when the door 318 is in the closed position of FIG. 9. The ribbed section 348 slopes downwardly, away from the bait station 310 and ribs of the ribbed section are oriented in a direction away from the bait station. A baffle 350 is provided at an end of the ribbed section 348 distal from the bait station 310, and this baffle extends generally transverse to the ribs. A space 351 is defined between each end of the baffle 350 and baffles 338. Baffle 350 directs liquid accumulating the ribbed section 348 through the space 351 for drainage via drainage openings 340.

A lip 354 is provided at the entrance to the race 316 and extends part-way from the floor 304 toward the top 308 of the body to inhibit liquid entering the race 316. The height of the bait platforms 311 is greater than the height of the lip 354 to ensure that should the device 300 become flooded, water will drain from the race 316 over the lip 354 before overtopping the platforms 311 supporting the bait 314.

The materials used in the third embodiment are the same as those used in the first embodiment for the same reasons as discussed above with reference to the first embodiment.

It will be appreciated that the illustrated embodiments are well adapted to inhibit liquid contact with the bait 114, 214, 314.

It will be appreciated by persons skilled in the art that numerous variations and/or modifications may be made to the embodiments described above with reference to the drawings without departing from the scope of the present disclosure as broadly defined. The present embodiments are, therefore, to be considered in all respects as illustrative and not restrictive. Examples of possible modifications include, but are not limited to:
providing additional baffles and/or drainage openings;
forming the drain channel 332 in the door 318;
forming the bait dispensing devices from other plastics, such as polycarbonate, nylon and PET;
replacing the pin-type hinge of the first embodiment with a hinge integrally moulded in one piece with the body and door;
providing keyed locks to the doors, with the keyed locks being located away from the bait area; and/or
modifying the embodiment of FIGS. 9-13 such that the top portion of the body overlaps the floor portion to create an awning-type edge.

1. A dispensing device for rodent baits, the dispensing device comprising:
a body having a floor, walls extending from the floor and a top extending between the walls;
a station located in the body for receiving a rodent bait;
a race extending into the body for permitting rodent access to the station;
a plurality of liquid ingress inhibiting formations in or around the race for inhibiting liquid contact with a bait in the station.

2. A dispensing device according to claim 1, wherein the liquid ingress inhibiting formations include a plurality of baffles extending from the floor toward the top of the body.

3. A dispensing device according to claim 2, wherein the baffles extend at least part way across the race.

4. A dispensing device according to claim 3, wherein the baffles are oriented to direct liquid in the race toward at least one of: a drainage opening in the floor, a wall of the body, and a position distal to the station.

5. A dispensing device according to claim 1, wherein the liquid ingress inhibiting formations include at least one drainage opening in the floor.

6. A dispensing device according to claim 5, wherein the at least one drainage opening is located adjacent one of the walls of the body.

7. A dispensing device according to claim 1, wherein the liquid ingress inhibiting formations include one or more sloped sections in the floor of the body.

8. A dispensing device according to claim 7, wherein the sloped sections are adapted to direct liquid in the race toward one or more of: the walls of the body, a drainage opening in the floor of the body, and an inlet for rodent entry into the race.

9. A dispensing device according to claim 7, wherein the sloped sections comprise a ramped portion at an opening for rodent entry into the race to inhibit liquid entering the race.

10. A dispensing device according to claim 7, wherein gradients of the sloped sections are between 3 and 10 degrees.

11. A dispensing device according to claim 1, wherein the liquid ingress inhibiting formations include a raised portion on which the station is formed, such that the station is raised by at least 2 mm relative to the floor of the body.

12. A dispensing device according to claim 1, wherein the liquid ingress inhibiting formations include a waterproof perimeter extending around the station.

13. A dispensing device according to claim 1, further comprising a door connected to the body, the door being movable between a closed position, in which the door covers the station, and an open position for permitting user access to the station for bait replenishment.

14. A dispensing device according to claim 13, wherein a locking mechanism is associated with the door for releasably securing the door in the closed position and wherein, when viewed from the top of the body, operative components of the locking mechanism are located outside a perimeter of the station.

15. A dispensing device according to claim 13, wherein the door includes a top portion extending over the station when the door is in the closed position and wherein, when viewed from the top of the body, the door periphery is located outside a perimeter of the station.

16. A dispensing device according to claim 15, wherein the liquid ingress inhibiting formations include a ribbed section in the floor of the body for dispersing liquid that may fall from the top of the body, the ribbed section being located under an intersection between the top portion of the door and the top of the body, when the door is in the closed position.

17. A dispensing device according to claim 16, wherein ribs of the ribbed section are oriented in a direction away from the station.

18. A dispensing device according to claim 17, comprising a baffle at an end of the ribbed section distal from the station and extending generally transverse to the ribs.

19. A dispensing device according to claim 18, wherein a drainage path from the ribbed section extends around the baffle toward a drainage opening in the floor.

20. A dispensing device according to claim 13, wherein the liquid ingress inhibiting formations include a drain extending around a periphery of the door.

21. A dispensing device according to claim 20, wherein the drain directs liquid accumulating on the top of the body or the top of the door to flow around the periphery of the door to a drainage point.

22. A dispensing device according to claim 20, wherein the drain is formed in the body.

23. A dispensing device according to claim 13, wherein the door is hingedly connected to the body and the liquid ingress inhibiting formations include a waterproof sleeve portion extending around the hinge between the door and the body.

24. A dispensing device according to claim 13, wherein the door is hingedly connected to the body and the liquid ingress inhibiting formations include a flange extending from the body, adjacent the door hinge, to direct liquid entering between the door and the body away from the station.

25. A dispensing device according to claim 13, wherein the liquid ingress inhibiting formations include at least one tab extending from a top portion of the door to engage a corresponding recess in the body, wherein overlapping areas between the at least one tab and the corresponding recess define liquid dripping points located outside a perimeter of the station.

26. A dispensing device according to claim 1, further comprising a lip extending part-way from the floor toward the top of the body to inhibit liquid entering the race.

27. (canceled)
